(19) United States
(12) Patent Application Publication
(10) Pub. No.: US 2009/0313824 A1
(43) Pub. Date: Dec. 24, 2009

(54) METHOD OF MAKING A FAN BLADE

(76) Inventor: Ching-Hui CHEN, Taichung City (TW)

Correspondence Address: FROMMER LAWRENCE & HAUG, 745 FIFTH AVENUE- 10TH FL., NEW YORK, NY, 10151, US

(21) Appl. No.: 12/204,319

(22) Filed: Sep. 4, 2008

(30) Foreign Application Priority Data
Jun. 24, 2008 (CN) 200820126930.1

(51) Int. Cl. B23P 15/04

(52) U.S. Cl. 29/889.71

(57) ABSTRACT

A method of making a fan blade includes: a) providing a blade body having a top surface, a bottom surface opposite to the top surface, and a peripheral wall interconnecting the top and bottom surfaces; b) drilling a blind hole in the blade body that extends from one side of the peripheral wall of the blade body and between the top and bottom surfaces of the blade body; and c) inserting a reinforcing rib into the blind hole.

### CROSS-REFERENCE TO RELATED APPLICATION

This application claims priority benefits of Chinese application no. 200820126930.1 filed on Jun. 24, 2008, the disclosure of which is hereby incorporated by reference.

### BACKGROUND OF THE INVENTION

1. Field of the Invention

This invention relates to a method of making a fan blade, more particularly to a method of making a fan blade involving forming a blind hole in the fan blade and inserting a reinforcing rib therein.

2. Description of the Related Art

FIG. 1 illustrates a conventional fan blade that is disclosed in U.S. Pat. No. 6,923,624 and that includes a blade body 1 extending along an axis (X) and having a top surface 101, a plurality of spaced-apart grooves 102 formed in the top surface 101 in a direction (Y) transverse to the axis (X), and a plurality of ribs 2 each fitted into a respective one of the grooves 102 so as to prevent deformation of the fan blade. Since the ribs 2 are not enclosed by the blade body 1, the appearance of the fan blade is adversely affected. To overcome this defect, a cover (not shown) can be attached to the top surface 101 of the blade body 1 so as to cover the ribs 2 and the grooves 102. A method of making such a conventional fan blade, however, is complicated and time-consuming.

### SUMMARY OF THE INVENTION

Therefore, an object of the present invention is to provide a method of making a fan blade that can overcome the aforesaid drawbacks associated with the prior art.

According to the present invention, a method of making a fan blade comprises: a) providing a blade body having a top surface, a bottom surface opposite to the top surface, and a peripheral wall interconnecting the top and bottom surfaces; b) drilling a blind hole in the blade body that extends from one side of the peripheral wall of the blade body and between the top and bottom surfaces of the blade body; and c) inserting a reinforcing rib into the blind hole.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective, partly exploded view of a conventional fan blade;

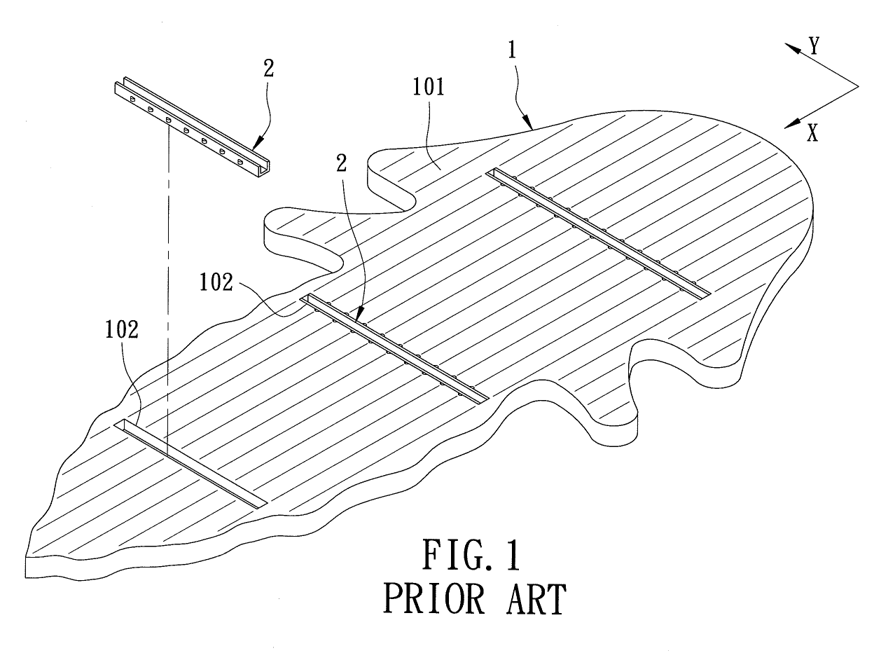

FIG. 2 is a perspective exploded view of the first preferred embodiment of a fan blade according to this invention;

FIG. 3 is a top view of the first preferred embodiment;

FIG. 4 is a cross-sectional view taken along line IV-IV in FIG. 3;

FIG. 5 is a fragmentary cross-sectional view taken along line V-V in FIG. 3;

FIG. 6 is a perspective exploded view of the second preferred embodiment of a fan blade according to this invention;

FIG. 7 is a top view of the second preferred embodiment; and

FIG. 8 is a cross-sectional view taken along line VIII-VIII in FIG. 7.

### DETAILED DESCRIPTION OF THE PREFERRED EMBODIMENTS

Before the present invention is described in greater detail with reference to the accompanying drawings, it should be noted herein that like elements are denoted by the same reference numerals throughout the disclosure.

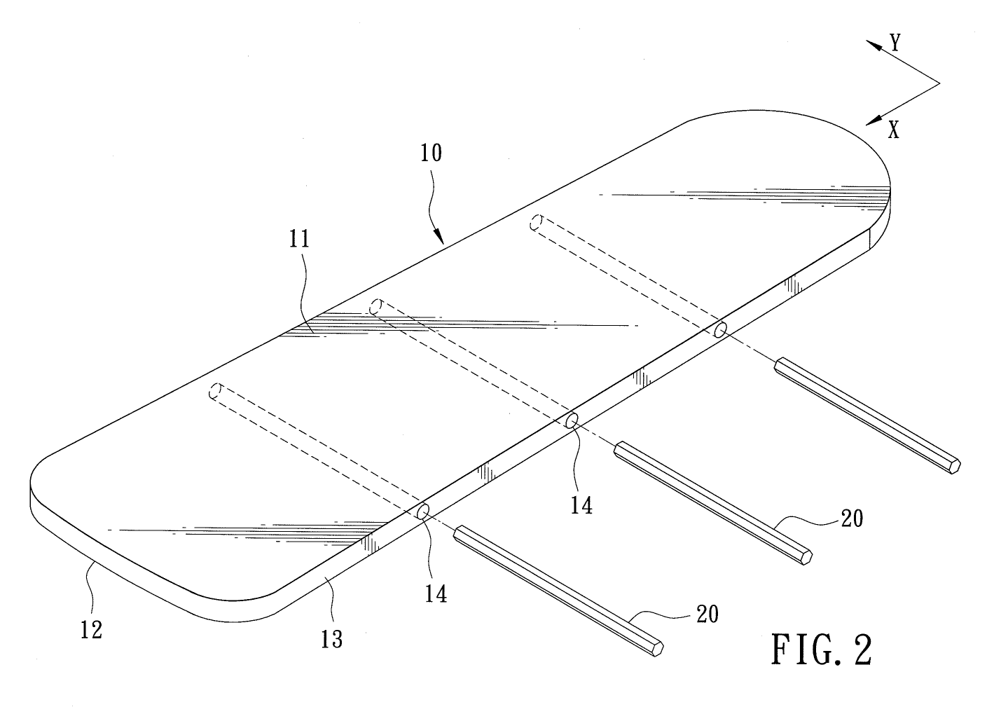

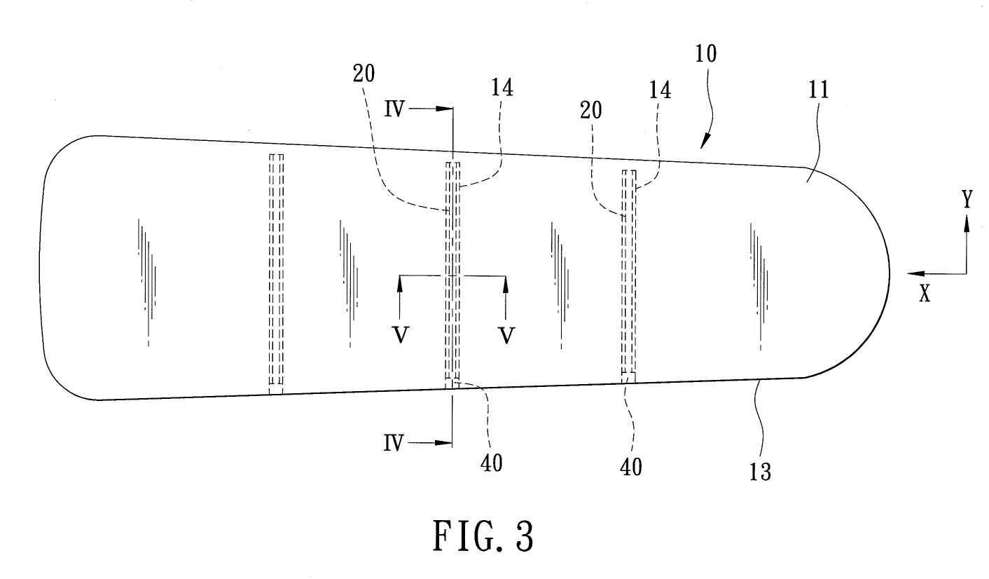

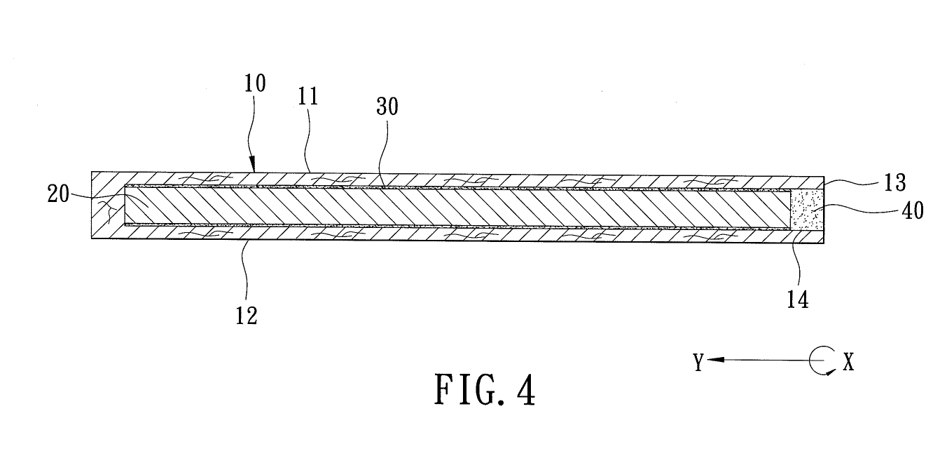

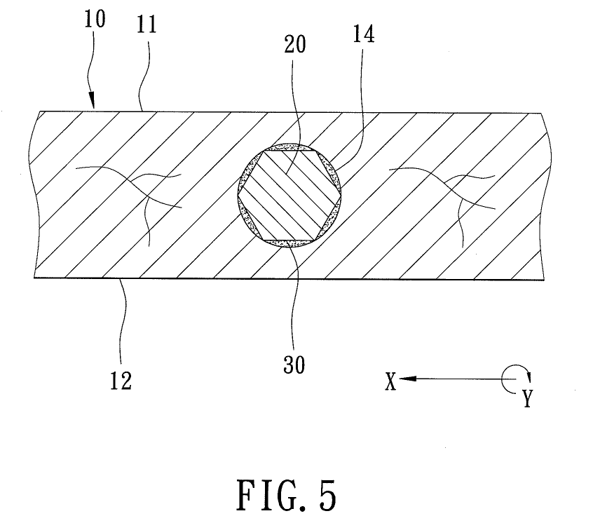

FIGS. 2 to 5 illustrate the first preferred embodiment of a fan blade according to this invention.

The fan blade includes a blade body 10 having a long axis (X), and further having a top surface 11, a bottom surface 12 opposite to the top surface 10, and a peripheral wall 13 interconnecting the top and bottom surfaces 11, 12. Blind holes 14 are formed in the blade body 10 starting from one side of the peripheral wall 13 of the blade body 10, and extending along a direction (Y) transverse to the long axis (X) of the blade body 10 between the top and bottom surfaces 11, 12 of the blade body 10. A reinforcing rib 20 is disposed in each blind hole 14.

In this embodiment, the fan blade further includes a plug 40 that is disposed in each blind hole 14 and that is adjacent to the peripheral wall 13 so as to seal the corresponding reinforcing rib 20 completely in the respective blind hole 14. In one embodiment, the plug 40 is made from an adhesive material.

Preferably, the blade body 10 is made of a wood material and each reinforcing rib 20 is made of a metal material.

In this embodiment, an adhesive 30 is introduced into each blind hole 14 and/or applied to each reinforcing rib 20 during manufacture so as to securely fix the reinforcing ribs 20 in the blind holes 14.

In this embodiment, each reinforcing rib 20 has a non-circular cross section, and the blade body 10 has hole-defining walls that define the blind holes 14 and that have a circular cross section.

It is noted that the number of each of the blind holes 14, the reinforcing ribs 20 and the plugs 40 can be one or more than one depending on actual requirements.

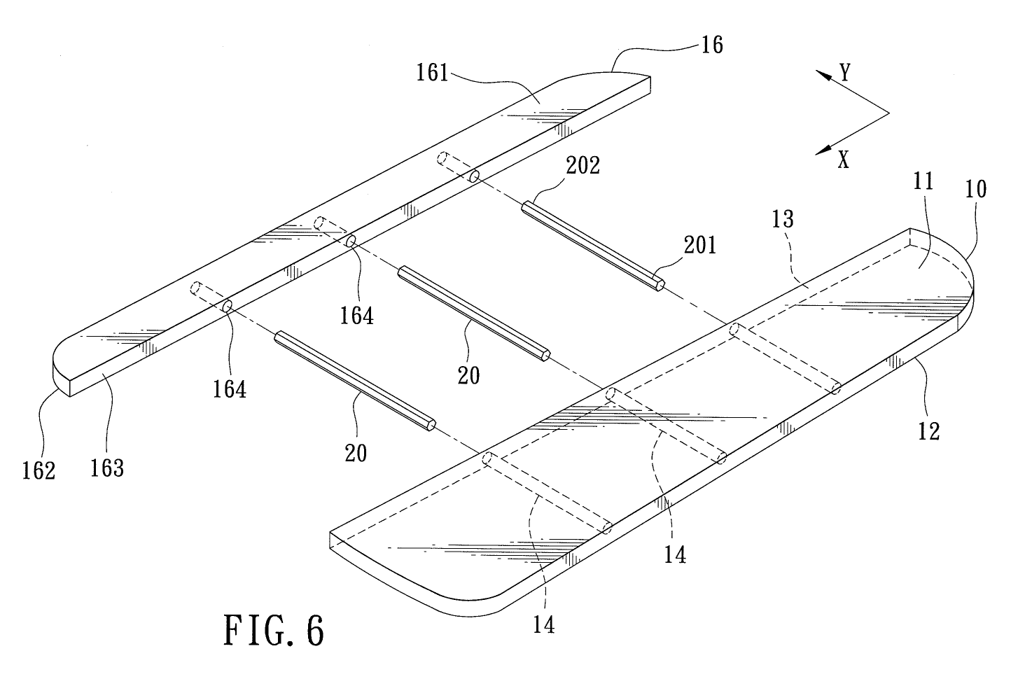

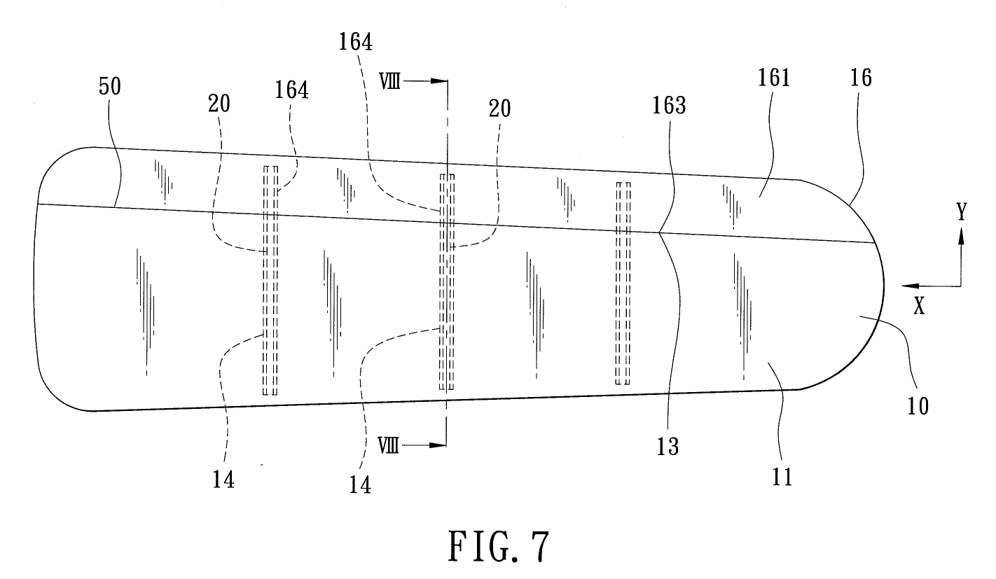

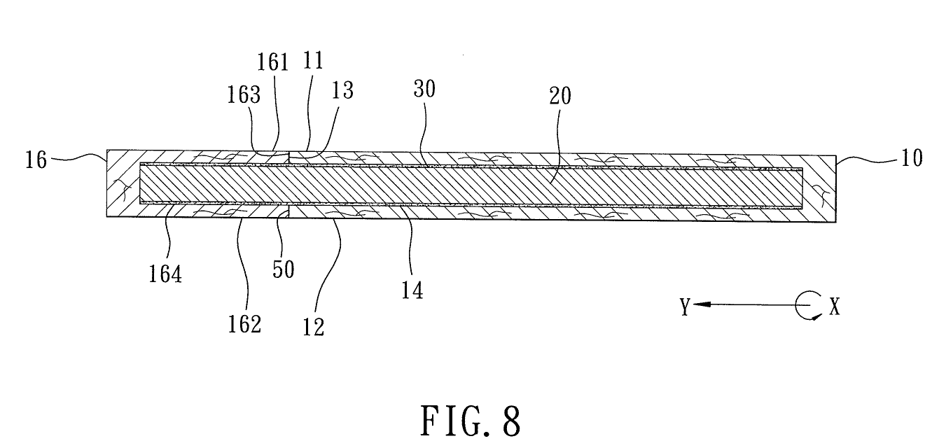

FIGS. 6 to 8 illustrate the second preferred embodiment of a fan blade according to the present invention. The second preferred embodiment differs from the previous embodiment in that the fan blade further has an auxiliary blade body 16, which has a structure substantially identical to that of the blade body 10. The auxiliary blade body 16 is formed with auxiliary blind holes 164. In addition, in this embodiment, each reinforcing rib 20 has a first end 201, and a second end 202 opposite to the first end 201. The first and second ends 201, 202 of each reinforcing rib 20 are inserted into the a corresponding blind hole 14 of the blade body 10 and a corresponding auxiliary blind hole 164 of the auxiliary blade body 16 respectively, so as to interconnect the blade body 10 and the auxiliary blade body 16.

Like the previous embodiment, the number of each of the blind holes 14, the auxiliary blind holes 164 and the reinforcing ribs 20 can be one or more than one depending on actual requirements.

Referring again to FIGS. 2 to 5, a method of making a fan blade according to a preferred embodiment of the present invention includes: a) providing a blade body 10 having a top surface 11, a bottom surface 12 opposite to the top surface 10, and a peripheral wall 13 interconnecting the top and bottom surfaces 11, 12; b) drilling at least one blind hole 14 in the blade body 10 that extends from one side of the peripheral wall 13 of the blade body 10, between the top and bottom surfaces 11, 12 of the blade body 10, and along a direction (Y) transverse to a long axis (X) of the blade body 10; and c) inserting a reinforcing rib 20 into the blind hole 14.

In this embodiment, the method further includes inserting a plug 40 into each blind hole 14 behind the corresponding reinforcing rib 20 so as to seal the reinforcing rib 20 completely in the respective blind hole 14.

Further, in this embodiment, step c) includes at least one of applying an adhesive 30 to the reinforcing rib 20 and introducing the adhesive 30 into the blind hole 14 before inserting the reinforcing rib 20 into the blind hole 14.

In some embodiments, with reference to FIGS. 6 to 8, the reinforcing rib 20 has a first end 201 and a second end 202 opposite to the first end 201, and, in step c), the first end 201 of the reinforcing rib 20 is inserted into the blind hole 14 of the blade body 10. In such embodiments, the method of making a fan blade further includes: d) providing an auxiliary blade body 16 having a top surface 161, a bottom surface 162 opposite to the top surface 161, and a peripheral wall 163 interconnecting the top and bottom surfaces 161, 162; e) drilling at least one auxiliary blind hole 164 in the auxiliary blade body 16 that extends from one side of the peripheral wall 163 of the auxiliary blade body 16 and between the top and bottom surfaces 161, 162 of the auxiliary blade body 16; and f) inserting the second end 202 of the reinforcing rib 20 into the auxiliary blind hole 164.

In such embodiments described with reference to FIGS. 6 to 8, the method may further include applying an adhesive 50 to at least one of said one side of the peripheral wall 13 of the blade body 10 and said one side of the peripheral wall 163 of the auxiliary blade body 16, and pressing said one side of the peripheral wall 13 of the blade body 10 against said one side of the peripheral wall 163 of the auxiliary blade body 16, thereby firmly securing the blade body 10 and the auxiliary blade body 16 to each other.

By drilling the blind hole 14 in the blade body 10 that extends from one side of the peripheral wall 13 of the blade body 10, and inserting the reinforcing rib 20 into the blind hole 14, the aforesaid drawbacks associated with the prior art can be eliminated. A similar effect may be obtained when the method of making a fan blade of the present invention includes the additional steps associated with making the fan blade shown in FIGS. 6 to 8.

With the invention thus explained, it is apparent that various modifications and variations can be made without departing from the spirit of the present invention. It is therefore intended that the invention be limited only as recited in the appended claims.

What is claimed is:

1. A method of making a fan blade, comprising:
a) providing a blade body having a top surface, a bottom surface opposite to the top surface, and a peripheral wall interconnecting the top and bottom surfaces;
b) drilling a blind hole in the blade body that extends from one side of the peripheral wall of the blade body and between the top and bottom surfaces of the blade body; and
c) inserting a reinforcing rib into the blind hole.

2. The method of claim 1, further comprising inserting a plug into the blind hole behind the reinforcing rib so as to seal the reinforcing rib completely in the blind hole.

3. The method of claim 1, wherein step c) includes at least one of applying an adhesive to the reinforcing rib and introducing an adhesive into the blind hole before inserting the reinforcing rib into the blind hole.

4. The method of claim 1, wherein the blade body has a long axis, and, in step b), the blind hole is drilled to extend along a direction transverse to the long axis of the blade body.

5. The method of claim 1, wherein the blade body is made of a wood material.

6. The method of claim 1, wherein the reinforcing rib is made of a metal material.

7. The method of claim 1, wherein the reinforcing rib has a non-circular cross section, and, in step b), the blind hole is drilled such that a hole-defining wall of the blade body forming the blind hole has a circular cross section.

8. The method of claim 1, wherein the reinforcing rib has a first end and a second end opposite to the first end, and, in step c), the first end is inserted into the blind hole, said method further comprising:
d) providing an auxiliary blade body having a top surface, a bottom surface opposite to the top surface, and a peripheral wall interconnecting the top and bottom surfaces;
e) drilling an auxiliary blind hole in the auxiliary blade body that extends from one side of the peripheral wall of the auxiliary blade body and between the top and bottom surfaces of the auxiliary blade body; and
f) inserting the second end of the reinforcing rib into the auxiliary blind hole.

9. The method of claim 8, further comprising applying an adhesive to at least one of said one side of the peripheral wall of the blade body and said one side of the peripheral wall of the auxiliary blade body, and pressing said one side of the peripheral wall of the blade body against said one side of the peripheral wall of the auxiliary blade body.
